(19) United States
(12) Patent Application Publication
(10) Pub. No.: US 2012/0240789 A1
(43) Pub. Date: Sep. 27, 2012

(54) SYSTEMS AND METHODS FOR MELTING AND MAINTAINING TEMPERATURE OF SEMI-SOLID COOKING MEDIA

(76) Inventors: Melissa M. HOHLER, Kettering, OH (US); Jon Barry LOHNES, Eaton, OH (US)

(21) Appl. No.: 13/053,060

(22) Filed: Mar. 21, 2011

(51) Int. Cl. A47J 37/12

(52) U.S. Cl. 99/403

(57) ABSTRACT

A fryer apparatus includes at least one cooking vessel that stores a cooking medium therein, a melter, a flow path, and a hopper pump that draws cooking medium from the melter to the cooking vessel. The melter includes a hopper that stores the cooking medium, a cradle, and a wiring. The cradle surrounds the hopper on 3 sides and the bottom, and the hopper may be removably inserted into the cradle. The cradle includes two side walls, a rear wall, and a bottom wall. A heating element is placed on an interior of each wall. When the hopper is installed in the cradle, heat is transmitted from the heating elements of the cradle through the hopper, and into the cooking medium, which allows the cooking medium to be stored at a temperature above an ambient temperature.

### BACKGROUND OF THE INVENTION

1. Field of the Invention

The present invention relates generally to cooking medium systems that use semi-solid cooking media, and use of a melter to maintain a temperature of the cooking medium prior to use in the fryer. The cooking medium systems described herein may be adapted to be used with solid cooking media designs.

2. Description of Related Art

Known fryers, e.g., open-well fryers and pressure fryers, are used to cook various food products, e.g., poultry, fish, potato products, and the like. Such fryers may include one or more cooking vessels, e.g., fryer pots, which may be filled with a cooking medium, e.g., an oil, a liquid shortening, or a meltable-solid shortening. Such fryers also include a heating element, e.g., an electrical heating element, such as a heating oil medium, or a gas heating element, such as a gas burner and gas conveying tubes, which heat the cooking medium in the cooking vessel. The amount of time sufficient to cook or to complete the cooking of the food product at a given cooking temperature depends on the type of food product which is cooked. Moreover, the cooking medium may be used during several cooking cycles before the cooking medium inside the cooking vessel is filtered, replaced, or supplemented with a new or filtered supply of cooking medium.

Known fryer apparatuses may include one or more vats which supply cooking medium to one or more frypots. This stored cooking medium may be supplied via one or more fryer plumbing lines. Before the cooking medium is transferred through the fryer plumbing lines to the vats, the cooking medium may be stored at ambient, i.e., room temperature. Moreover, known systems may have frypots designed to use cooking medium that is in a solid or semi-solid state, e.g., a shortening (hereinafter “solid cooking medium” or “semi-solid cooking medium”). Nevertheless, as solid or semi-solid cooking medium is delivered from a storage vat to a cooking vessel, the consistency of the cooking medium at ambient temperature may increase the difficulty of transferring the solid or semi-solid cooking medium through the fryer plumbing lines. Specifically, the cooking medium may transfer slowly, or may build up and create narrower passages, blockages, and degraded performance of the fryer apparatus. Moreover, because the stored semi-solid cooking medium may be stored at ambient temperature, it may be difficult to use the excess cooking medium to clear the flow path of the fryer apparatus.

### SUMMARY OF THE INVENTION

Therefore, a need has arisen for systems and methods for a cooking apparatus that overcome these and other shortcomings of the related art. A technical advantage of the invention is that even when using a solid or semi-solid shortening as a cooking medium, cooking medium may be delivered for cooking operations without risk of jamming the fryer lines, preventing malfunctions and allowing smooth operation of the fryer apparatus.

In an embodiment of the invention, an apparatus for storing and delivering cooking medium comprises at least one cooking vessel configured to cook food therein by heating cooking medium to a cooking temperature, a melter comprising, a hopper configured to store the cooking medium, a cradle configured to surround the hopper on at least three sides and the bottom, wherein the cradle comprises a first side wall and a second side wall opposite the first side wall, a rear wall positioned at an end of the first side wall and the second side wall, a bottom wall positioned at a bottom of the first side wall, second side wall, and rear wall, and a plurality of heating elements positioned at each of the first side wall, second side wall, rear wall, and bottom wall. The melter further comprises a wiring connected to each of the plurality of heating elements and extending away from the melter and connected to an external power supply. The apparatus further comprises a flow path connecting the at least one cooking vessel and the melter; and a hopper pump positioned in the flow path and configured to draw cooking medium from the melter to the at least one cooking vessel.

In another embodiment of the invention, a melter comprises a hopper configured to store a cooking medium therein, a cradle configured to surround the hopper on at least three sides and the bottom, wherein the hopper is configured to be removably inserted into the cradle, a wiring connected the hopper and to an external power supply, a suction tube that extends from the hopper, and a disconnect joint positioned at an end of the suction tube opposite to the hopper. The cradle comprise a first side wall, a first side heating element positioned on one side of the first side wall that faces the second side wall, a second side wall opposite the first side wall, a second side heating element positioned on one side of the second side wall that faces the first side wall, a rear wall positioned at an end of the first side wall and the second side wall, a rear heating element positioned on one side of the rear wall that faces the first and second side walls, a bottom wall positioned at a bottom of the first side wall, second side wall, and rear wall, and a bottom heating element positioned on one side of the bottom wall that faces the first side wall, second side wall, and rear wall. Each of the first side heating element, second side heating element, rear heating element, and bottom heating element are connected to the wiring, and when the hopper is inserted into the cradle, and power is transferred through the wiring, each of the first side heating element, second side heating element, rear heating element, and bottom heating element are configured to transfer heat from the cradle through the hopper, to increase or maintain a temperature of the cooking medium.

Other objects, features, and advantages of the present invention will be apparent to persons of ordinary skill in the art in view of the foregoing detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a front view of a fryer apparatus using a melter, according to an embodiment of the invention.

FIG. 2A is a perspective view of a melter including a hopper inserted into a cradle, according to an embodiment of the invention.

FIG. 2B is a front view of the hopper inserted into the cradle, according to an embodiment of the invention.

FIG. 3A is a perspective view of the hopper, according to an embodiment of the invention.

FIG. 3B is a top-down view of the hopper, according to an embodiment of the invention.

FIG. 3C is a front view of the hopper, according to an embodiment of the invention.

FIG. 4A is a side view of the hopper inserted into the cradle, according to an embodiment of the invention.

FIG. 4B is a side view of the hopper as it is withdrawn from the cradle, according to an embodiment of the invention.

FIG. 4C is a perspective view of the cradle when the hopper is separated from the cradle, according to an embodiment of the invention.

FIG. 5 is a front view of the exterior cover of the cradle before the interior cover of the cradle is affixed, according to an embodiment of the invention.

FIG. 6 is a partially exploded perspective view of the cradle showing the interior cover partially affixed to the exterior cover of the cradle, according to an embodiment of the invention.

FIG. 7 is an exploded view of a side and rear walls of the assembled cradle, according to an embodiment of the invention.

### DETAILED DESCRIPTION OF EMBODIMENTS OF THE INVENTION

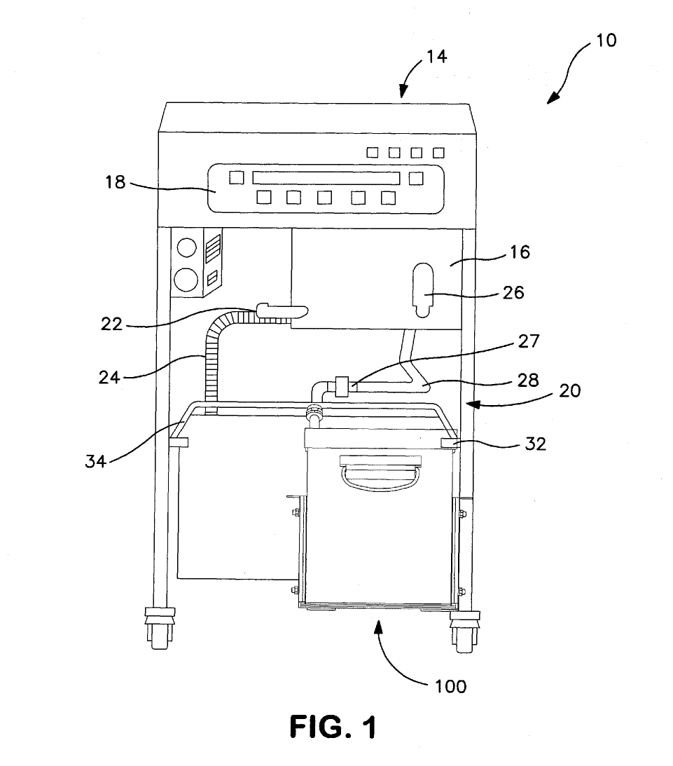

Preferred embodiments of the present invention, and their features and advantages, may be understood by referring to FIGS. 1-7, like numerals being used for corresponding parts in the various drawings.

According to FIG. 1, a fryer apparatus 10 may comprise a single frypot 16. Although only one frypot 16 is depicted in FIG. 1, in other embodiments of the invention, multiple frypots may be used. Fryer apparatus 10 comprises a frypot 16 having an open top 14 for receiving a food product. A cabinet 20, shown without a door for illustrative purposes, may comprise brackets 32 supporting a melter 100 having a filter (not shown). Melter 100 may be fluidly connected to frypot 16 via a flow pipe 28. A pump 27 may be positioned on flow pipe 28, for drawing cooking medium into frypot 16 from melter 100. A visual control readout panel 18 may be positioned on a front panel of fryer apparatus 10. Moreover, a control panel 18 may comprise a plurality of buttons, including a “POWER” button for cycling the fryer apparatus on and off. A controller (not shown) may control the input from control panel 18 and control, among other fryer apparatus 10 elements, pump 27. A handle 34 may support a drain pan (not shown) which may be attached to drain 24. Drain 24 may be controlled by drain control 22 and may allow used cooking medium to be drained from frypot 16, and the used cooking medium may be disposed of or recycled for storage and further use into melter 100.

As shown in FIG. 1, melter 100 may be placed below frypot 16. Nevertheless, in other embodiments, melter 100 may be placed in other locations relative to the frypot 16. In still other embodiments, melter 100 may be placed distant from fryer apparatus 10. Although only one melter 100 is illustrated in FIG. 1, in other embodiments, multiple melters 100 may be used, and may contain multiple different types of cooking media.

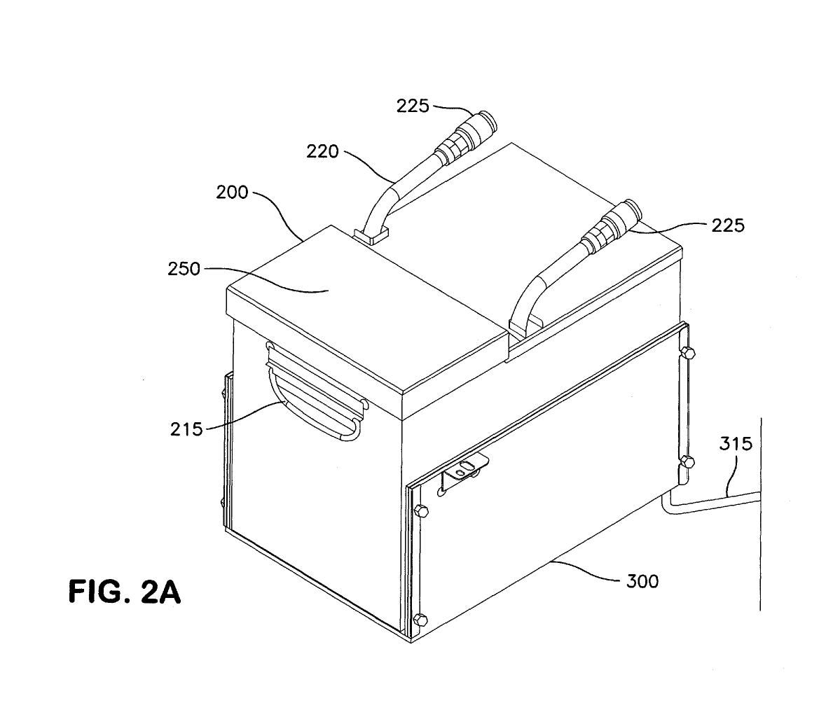

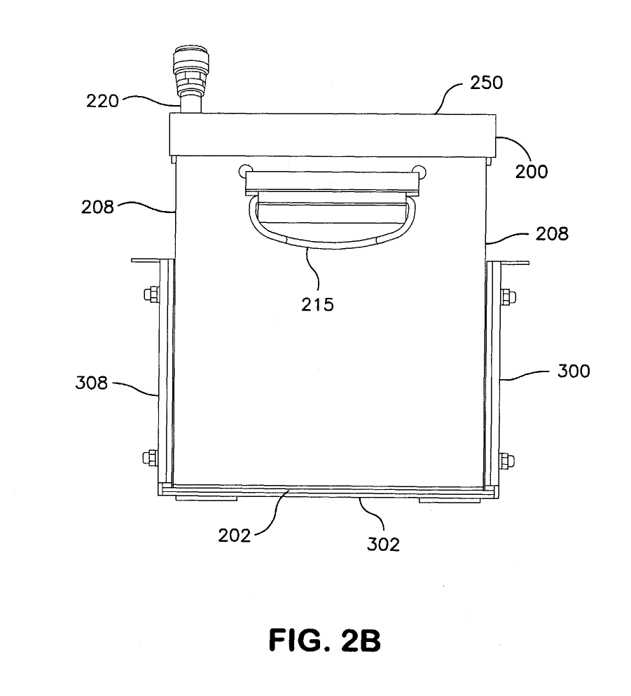

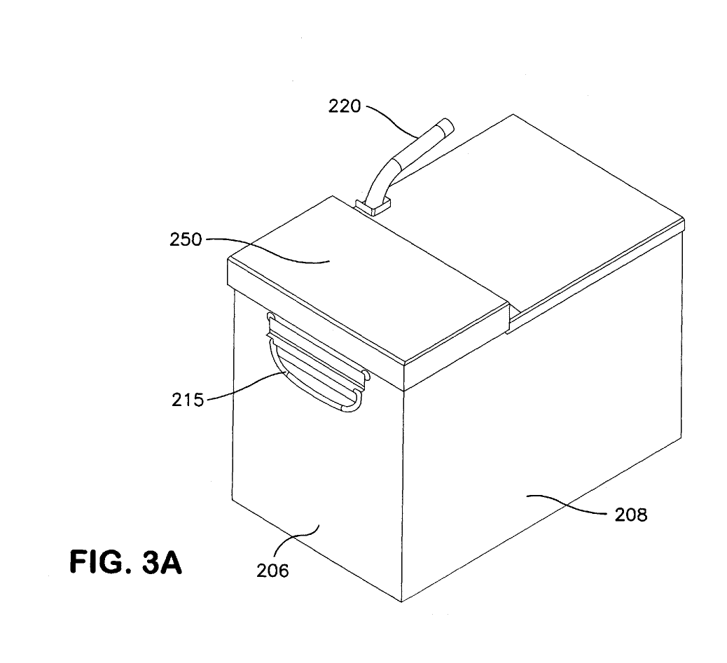

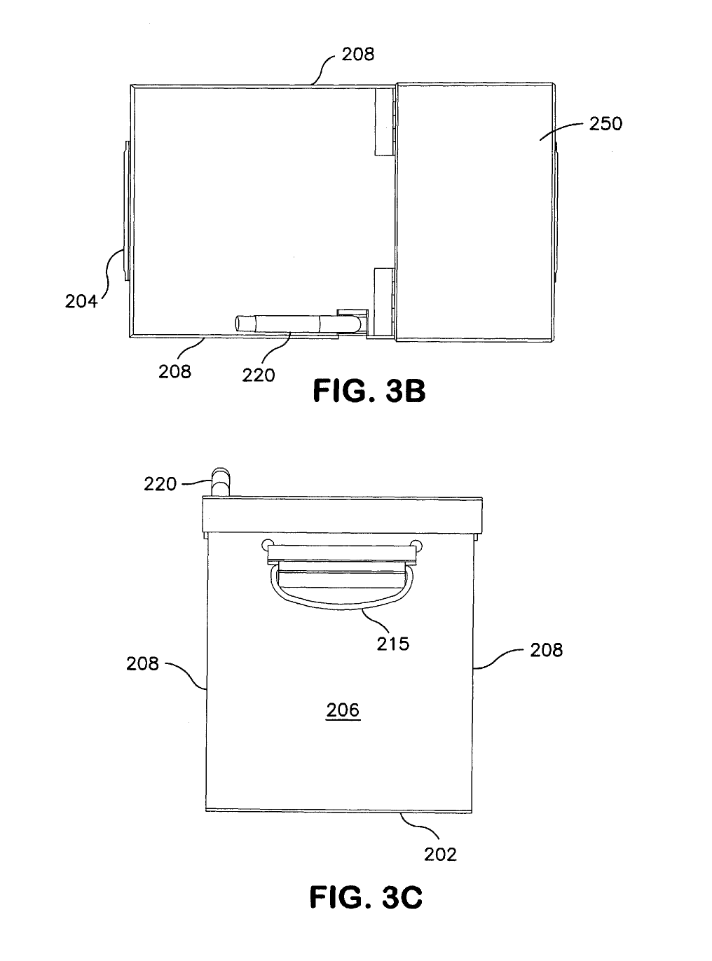

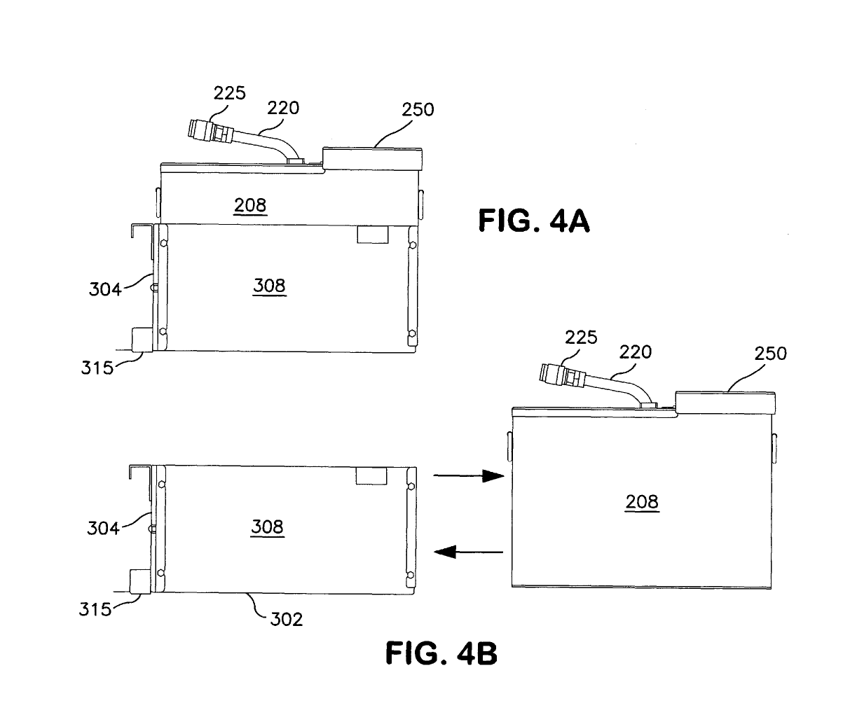

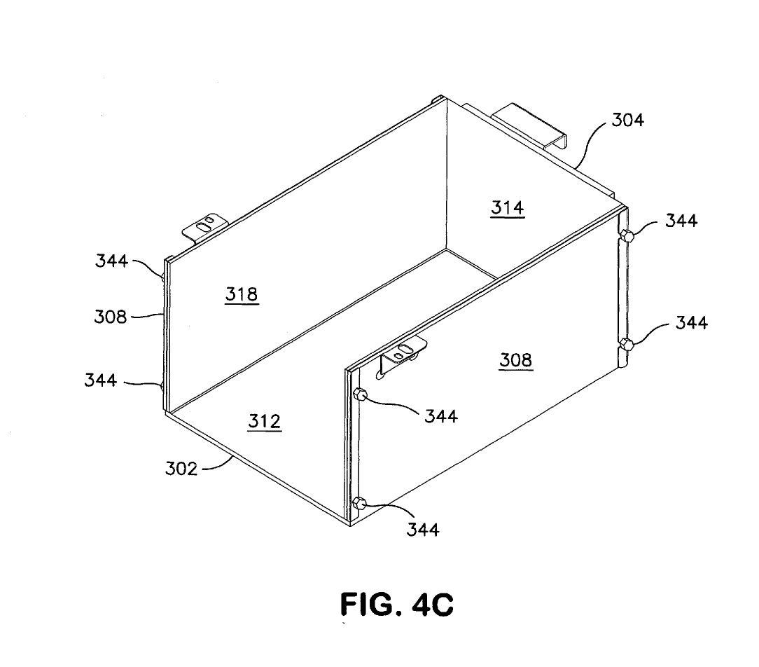

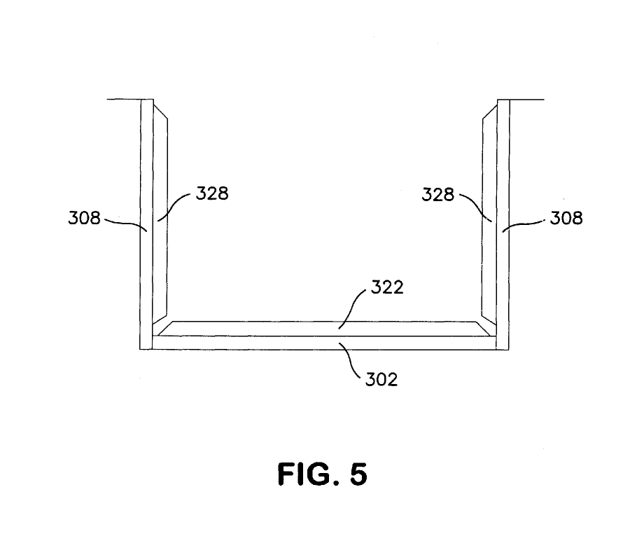

FIG. 2A shows a perspective view of melter 100, including hopper 200 stored in cradle 300. Similarly, FIG. 2B shows a front view of a front end of melter 100, including hopper 200 and cradle 300. Hopper 200 will be discussed in more detail herein with respect to FIGS. 3A-3C. Cradle 300 will be discussed in more detail herein with respect to FIGS. 4A-4C and FIG. 5. As shown in FIG. 2, hopper 200 removably fits snugly into cradle 300. As shown in FIG. 2A, hopper 200 includes two suction tubes 220. Nevertheless, as shown in FIG. 2B, and as implemented in the fryer shown in FIG. 1, other embodiments of hopper 200 may include only one suction tube 220. The number of suction tubes 220 may vary based on the specific application of hopper 200, and the number of hoppers 200 and frypots 16 that make up a particular implementation. Moreover, the suction tube may be placed on the right or the left side. Other embodiments of the invention may use more suction tubes 220, connected to one or more frypots 16.

FIG. 3A shows a perspective view of hopper 200 when it is removed from cradle 300. FIG. 3B shows a top-down view of hopper 200. FIG. 3C shows a top-down view of hopper 200. In an embodiment of the invention, hopper 200 may include front wall 206, two side walls 208, a rear wall 204, and a bottom wall 202. Side walls 208 and bottom wall 202 may comprise smooth surfaces in order to facilitate insertion and removal into cradle 300. Side walls 208 and bottom wall 202 may be constructed of solid stainless steel which allows heat transfer from hopper 200 while maintaining structural integrity. As shown in FIGS. 3A-3C, a handle 215 may be positioned at front wall for ease of removal for replacement, draining, or cleaning. A removable stainless steel lid 250 may cover the top of hopper 200. In an embodiment of the invention, cooking medium may be loaded through the top opening of hopper 200 when lid 250 is opened or removed. A suction tube 220 may be inserted into a top end of hopper 200. Suction tube 220 may be connected to the fryer apparatus through a flow path, and cooking medium may be drawn through suction tube 220 into the fryer apparatus by a pump in the flow path, e.g., the pump 27 described with respect to FIG. 1.

As shown in FIG. 2A, a disconnect coupling 225 may be attached to one end of suction tube 220. Disconnect coupling 225 may be added so that an operator of the fryer apparatus may quickly disconnect the hopper 200 from the fryer apparatus, and slide the hopper 200 out of cradle 300. In some embodiments of the invention, a quick disconnect, or quick release, coupling may be used to further facilitate efficient disconnection of hopper 200 from the fryer apparatus. In other embodiments of the invention, disconnect coupling 225 may be omitted, and not all drawings explicitly illustrate disconnect coupling 225 attached to suction tube 220. As shown in FIG. 4A, suction tube 220 may have approximately a ten (10) degree bend, which may allow for placement under frypot 16 without preventing flow of cooking medium through suction tube 220.

FIG. 4A shows a side view of cradle 300 and hopper 200, with hopper 200 inserted for perspective. FIG. 4B shows a side view of cradle 300 and hopper 200, with hopper 200 removed. As shown in FIG. 4B, hopper 200 may slide substantially horizontally away from cradle 300, in the direction shown by the arrows in FIG. 4B. FIG. 4C shows a perspective view of fully assembled cradle 300 with hopper 200 removed. FIG. 4D shows an exploded view of partially assembled cradle 300, to show the layers that form the silicon heater. As shown in FIGS. 4A-4C, cradle 300 has exterior side walls 308, rear wall 304, and exterior bottom wall 302. Cradle 300 also may have wiring 315 extending from rear wall 304 or bottom wall 302. Wiring 315 may connect with a metal conduit on the fryer, which may be connected to the power supply powering the fryer mechanism, i.e., an AC power supply. Wiring 315 may supply power to the silicon heater, as will be discussed in more detail herein.

Referring to FIG. 5, exterior side walls 308 of cradle 300 include stainless steel sides, which are provided with insulation layer 328. Similarly, bottom wall 302 includes a stainless steel wall and an insulation layer 322. Rear wall 304 may also have an insulation layer 324. Rear wall 304 is affixed at anchoring points 344, as described in more detail herein. The angles and sizes of insulation layers 328 and 322 illustrated in FIG. 5 have been exaggerated from their actual positions and orientations in order to show their detail. Although insulation layers 328 and 322 are separated by a gap in FIG. 5, this gap is not required for functionality and may be closed, omitted, or filled with a sealing substance or other insulator or adhesive. In another embodiment of the invention, insulation layers 328 and 322 may be omitted. In still another embodiment of the invention, insulation layers 322, 324, and 328 may be integrally formed and placed as one unit within cradle 300.

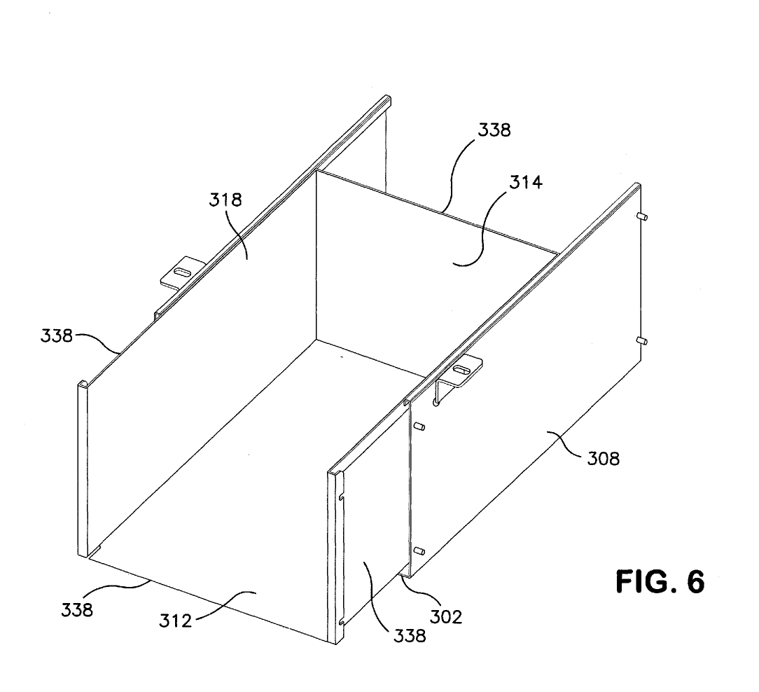

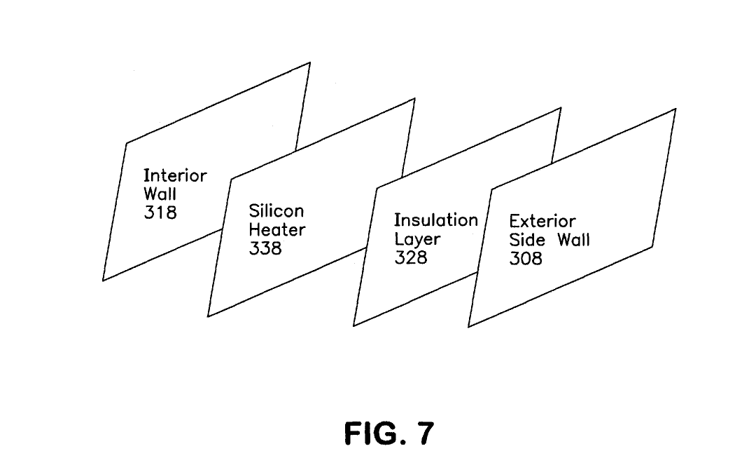

As shown in FIG. 6 and FIG. 7, silicon heater 338 then may be placed on the outside surface of rear wall 314, interior side walls 318, and interior bottom wall 312, as shown in FIG. 6. Then, the cradle is formed by sliding interior side walls 318, interior bottom wall 312, and rear wall 314, which contain the silicon heater 338, into the exterior side walls 308 and exterior bottom wall 302, as shown in FIG. 6. In the embodiments of the invention shown in the drawings, interior side walls 318, interior bottom wall 312, and rear wall 314 are integrally formed, but in other embodiments these parts may be separated.

Once the cradle is formed by sliding the interior walls into the exterior walls, the interior walls are affixed to the exterior walls at anchoring points 344, shown in FIG. 4C. This affixing may occur through any conventional means, i.e., screws, snap-on fasteners, adhesive, and the like.

As shown in FIG. 7, when completed, the cradle 300 of the melter has, in order from an exterior of the cradle to an interior of the cradle, an exterior side wall 308, an insulation layer 328, a silicon heater 338, and an interior wall 318. The opposite side, the bottom, and the rear wall have similar structures, with their corresponding reference numbers.

Silicon heater 338 may be connected to the wires 315, and when electricity is sent through the wires 315, the silicon heater 338 may generate heat from the electrical energy. In an embodiment of the invention, the heating pads are made of silicon. Nevertheless, in other embodiments, any elastic material suitable for transferring heat may be used. An elastic material is used to provide a snug fit when hopper 200 is inserted into cradle 300. During construction of cradle 300, silicon heater 338 may be affixed to an exterior side of interior bottom wall 312, side walls 318, and rear wall 304 through use of a glue, e.g., a pressure sensitive adhesive attached to an inner side of the heating pads.

When hopper 200 is installed in cradle 300, interior walls 318, 312, and 314 contact respective walls of 202, 204, and 208 of hopper 200, as shown in FIGS. 2A and 2B. When the fryer apparatus is energized, power is transmitted to the silicon heater 338, which generates heat. This heat generated by the silicon heater 338 is transferred through the walls of hopper 200 and into the cooking medium stored therein, thereby raising the temperature of the cooking medium. This increase in temperature may partially or completely liquefy the cooking medium stored therein, allowing for ease of dispensing the cooking medium through suction tube 220.

Thus, when the cradle is powered on, and silicon heater 338 is generating heat, the cooking medium inside hopper 200 may be kept at a constant temperature that is above the ambient temperature. In this manner, solid and semi-solid cooking medium may be stored in hopper 200 for instant use. Specifically, when the silicon heater 338 is operating, cooking medium inside hopper 200 may be kept at a temperature at which the cooking medium may be delivered through suction tube 220 and flow pipe 28 to the frypot 16 without sticking to the suction tube 220 and flow pipe 28 or otherwise restricting flow through the flow pipe 28. This system allows an amount of cooking medium in frypot 16 to be adjusted more quickly, which facilitates keeping an amount of cooking medium in the frypot to remain relatively constant. Moreover, this system allows for an easier cleaning and purging of the piping connecting melter 100 and frypot 16.

Although the heating elements in this application have been referred to as silicon heaters, any type of heating element which converts electrical energy to heat energy may be used interchangeably. Moreover, insulation layers 328 and 322 may be formed of any material suitable for slowing heat transfer beyond the properties of stainless steel.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. The specification and the described examples are considered as exemplary only, with the true scope and spirit of the invention indicated by the following claims.

1. An apparatus for storing and delivering cooking medium, the apparatus comprising:
at least one cooking vessel configured to cook food therein by heating a semi-solid cooking medium to a cooking temperature;
a melter comprising:
a hopper configured to store the cooking medium;
a cradle configured to surround the hopper on at least three sides and the bottom, such that the hopper is removably insertable into the cradle, wherein the cradle comprises:
a first side wall and a second side wall opposite the first side wall;
a rear wall positioned at an end of the first side wall and the second side wall;
a bottom wall positioned at a bottom of the first side wall, second side wall, and rear wall; and
a heating element positioned at each of the first side wall, second side wall, rear wall, and bottom wall; and
a wiring connected to the heating element and extending away from the melter and connected to an external power supply;
a flow path connecting the at least one cooking vessel and the melter; and
a hopper pump positioned in the flow path and configured to draw liquid cooking medium from the melter to the at least one cooking vessel.

2. The apparatus of claim 1, further comprising:
a power source configured to generate power,
wherein the heating element and the cooking vessel are connected to the power source, such that the heating element generates heat when the cooking vessel is energized.

3. The apparatus of claim 1, further comprising:
a controller configured to activate the hopper pump to deliver liquid cooking medium from the melter to the cooking vessel,
wherein the heating element is configured to maintain the liquid or semi-solid cooking medium at a predetermined temperature.

4. The apparatus of claim 3, wherein the predetermined temperature is a temperature at which the cooking medium is in a semi-solid or liquid state, wherein the cooking medium is a solid when maintained at an ambient temperature.

5. The apparatus of claim 3, wherein the heating element comprises a plurality of silicon pads fixed to respective walls by an adhesive.

6. The apparatus of claim 5, wherein each silicon pad of the heating element is a single pad covering the entire respective wall to which the single pad is affixed.

7. The apparatus of claim 1, wherein the hopper comprises a handle, and is configured to be removably inserted into the hopper.

8. The apparatus of claim 7, wherein the hopper comprises a suction tube that extends from the hopper and forms a portion of the flow path.

9. The apparatus of claim 7, wherein the hopper comprises a disconnect coupling positioned at an end of the suction tube and configured to attach to a pipe of the apparatus to form the flow path.

10. The apparatus of claim 9, wherein the disconnect coupling is a quick disconnect coupling configured to be coupled and decoupled without the use of a tool.

11. The apparatus of claim 7, wherein the hopper further comprises a removable lid, wherein when the hopper is removed from the cradle, the removable lid may be removed, and cooking medium may be loaded into the hopper.

12. A melter comprising:
a hopper configured to store cooking medium therein;
a cradle configured to surround the hopper on at least three sides and the bottom, wherein the hopper is configured to be removably inserted into the cradle;
a wiring connected the hopper and to an external power supply;
a suction tube that extends from the hopper; and
a disconnect joint positioned at an end of the suction tube opposite to the hopper, wherein the cradle comprises:
a first side wall;
a second side wall opposite the first side wall;
a rear wall positioned at an end of the first side wall and the second side wall;
a bottom wall positioned at a bottom of the first side wall, second side wall, and rear wall; and
a heating element positioned on one side of the first side wall that faces the second side wall, on one side of the second side wall that faces the first side wall, on one side of the rear wall that faces the first and second side walls, and on one side of the bottom wall that faces the first side wall, second side wall, and rear wall;
wherein the heating element connected to the wiring, and when the hopper is inserted into the cradle, and power is transferred through the wiring, the heating element is configured to transfer heat from the cradle through the hopper, to increase or maintain a temperature of the cooking medium.

13. The apparatus of claim 12, wherein the first side wall comprises a first interior side wall and a first exterior side wall, the second side wall comprises a second interior side wall and a second exterior side wall, and the bottom wall comprises an interior bottom wall and an exterior bottom wall, and wherein
a first portion of the heating element is positioned between the first interior side wall and the first exterior side wall;
a second portion of the heating element is positioned between the second interior side wall and the second exterior side wall; and
a third portion of the heating element is positioned between the bottom interior wall and the bottom exterior wall.

14. The melter of claim 13, further comprising:
a first insulation positioned between the first interior side wall and the first exterior side wall;
a second insulation positioned between the second interior side wall and the second exterior side wall; and
a third insulation positioned between the bottom interior wall and the bottom exterior wall.

15. The apparatus of claim 1, wherein the heating element is a silicone heating element.

16. The melter of claim 12, wherein the heating element is a silicone heating element.
